(19) United States
(12) Patent Application Publication
(10) Pub. No.: US 2025/0074325 A1
(43) Pub. Date: Mar. 6, 2025

(54) ASSEMBLIES, SYSTEMS AND METHODS TO TRANSPORTABLY STORE FISHING EQUIPMENT

(71) Applicant: Tim J. Nation, Kamas, UT (US)

(72) Inventor: Tim J. Nation, Kamas, UT (US)

(21) Appl. No.: 18/818,449

(22) Filed: Aug. 28, 2024

Related U.S. Application Data
(60) Provisional application No. 63/580,108, filed on Sep. 1, 2023.

(51) Int. Cl. B60R 9/08; A01K 97/10

(52) U.S. Cl. CPC B60R 9/08; A01K 97/10

(57) ABSTRACT

An assembly includes a module. The module includes one or more holsters each including a notch disposed at a first end of the one or more holsters and configured to couple with a fishing reel. Each of the one or more holsters can define a housing configured to receive a fishing rod. The assembly includes a first support member coupled with a first end of the module. The assembly includes a second support member coupled with a portion of the module between the first end of the module and a second end of the module.

### CROSS-REFERENCE TO RELATED PATENT APPLICATION

This application claims the benefit and priority of U.S. Provisional Patent Application No. 63/580,108, filed on Sep. 1, 2023, the entirety of which is incorporated by reference herein.

### TECHNICAL FIELD

The present disclosure is directed to fishing equipment, and, more particularly, storage and transportation of a fishing rod and reel, etc.

### BACKGROUND

A fishing rod and reel can be a cumbersome tool to store and transport between home and a fishing destination.

### SUMMARY

At least one aspect of the present disclosure is directed to an assembly. The assembly can include a module. The module can include one or more holsters each including a notch disposed at a first end of the one or more holsters and configured to couple with a fishing reel. Each of the one or more holsters can define a housing configured to receive a fishing rod. The assembly can include a first support member coupled with a first end of the module. The assembly can include a second support member coupled with a portion of the module between the first end of the module and a second end of the module.

Another aspect of the present disclosure is directed to a method. The method can include providing a module. The module can include one or more holsters each including a notch disposed at a first end of the one or more holsters and configured to couple with a fishing reel. Each of the one or more holsters can define a housing configured to receive a fishing rod. The method can include coupling a first support member with a first end of the module. The method can include coupling a second support member with a portion of the module between the first end of the module and a second end of the module.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a perspective view of an assembly, according to an embodiment.

FIG. 2 is a rear view of the assembly, according to an embodiment.

FIG. 3 is a partial side view of the assembly, according to an embodiment.

FIG. 4 is a side view of the assembly, according to an embodiment.

FIG. 5 is an opposite side view of the assembly, according to an embodiment.

FIG. 6 is a perspective view of the assembly, according to an embodiment.

FIG. 7 is a side view of the assembly, according to an embodiment.

FIG. 8 is an opposite side view of the assembly, according to an embodiment.

FIG. 9 illustrates a flow diagram of a method of storing fishing equipment, according to an embodiment.

Like reference numbers and designations in the various drawings indicate like elements.

### DETAILED DESCRIPTION

Following below are more detailed descriptions of various concepts related to, and implementations of, assemblies, systems, apparatuses, and methods for storing and transporting fishing equipment (e.g., one or more fishing rods and reels, one or more fishing rods/reels). The systems and methods described herein, more particularly, disclose an assembly useful for storing and/or transporting one or more fishing rods, each having assembled thereto a fishing reel. The assembly disclosed herein avoids common problems associated with storing and/or transporting fishing rods and reels. For example, the assembly can greatly reduce the possibility of breakage of either the rod or the reel, line tangling and/or breaking, tension maladjustment, rod segment mismatching, and other damage. Notably, use of the disclosed assembly can permit easy storage of a fully assembled fishing rod and reel, which can, inherently, make starting (and finishing) fishing easier.

The various concepts introduced above and discussed in greater detail below may be implemented in any of a number of ways, as the described concepts are not limited to any particular manner of implementation. Examples of specific implementations and applications are provided primarily for illustrative purposes. Additional aspects and advantages will be apparent from the following detailed description of preferred embodiments, which proceeds with reference to the accompanying drawings.

Fishing rods come in a wide variety of lengths and with differing degrees of flex/rigidity and flex profiles. Fishing rods are configured for a type of casting (short, long, fly, etc.), with different lengths depending on use, and have different degrees of rigidity or flex profile (modulus). Fishing rods can be made from a variety of materials, some of which are less durable than others. Each fishing rod serves a particular purpose, wherefore, it is not unusual for one fisherperson to have a plurality of fishing rods to meet the demands of any fishing situation.

Just as fishing rods serve different purposes, so, too, do fishing reels. Each fishing reel may be configured to a particular situation, or a particular style or method of fishing, and is mated to like-purposed fishing rods. A fishing reel is customizable, having adjustable drag/tension, being loaded with a selected weight (strength) of line, employing a different bail type, etc. The fishing reel, while attached to a fishing rod, is disposed in such a way that it is susceptible to being damaged while in transport, or, if not outright damaged, may become misadjusted (e.g., a bump or knock may result in the drag changing, etc.).

While stored (and while being moved about in storage) or being transported, a fishing rod may get broken, tangled with another fishing rod or other gear or appurtenance, etc. The fishing rod can be prone to breakage due to its construction and unwieldy dimension. When multiple rods are stored or transported together, there can be a tendency for lines to become tangled. Likewise, a fishing reel attached to the fishing rod may become damaged or lose adjustment. The fishing reel, when transported, may be subject to being knocked about, risking breakage or inducing maladjustment (e.g., tension change, line tangling on the reel, etc.). The fishing rod/reel holster of the present disclosure protects fishing rods and reels from such damage, maladjustment, or the like.

The following description describes embodiments of the present disclosure with primary reference to systems and methods of storing and transporting one or more fishing rods and reels.

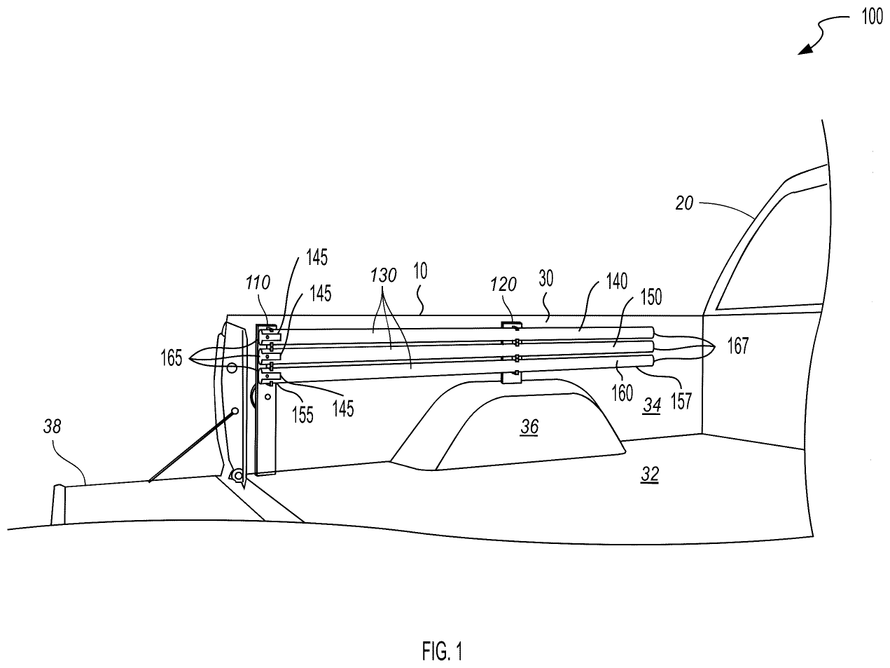

FIG. 1 illustrates a perspective view of an assembly 100 (e.g., fishing rod/reel holster assembly, RRHA), according to one embodiment of the present disclosure. The assembly 100 can be disposed in a vehicle 10 (e.g., truck). For example, the assembly 100 can be disposed in a light truck. A cab 20 and a bed 30 (e.g., cargo area, truck bed) of the vehicle 10 are identified. A floor 32 of the bed 30, a sidewall 34 of the bed 30, a wheel well 36 (e.g., wheel fender), and a tailgate 38 are shown. The assembly 100 can be disposed at the sidewall 34 of the vehicle 10. The assembly 100 can be coupled to the sidewall 34 of the bed 30 of the vehicle 10. For example, the assembly 100 can be attached to and removed from the sidewall 34 of the vehicle 10.

The assembly 100 can include one or more support members. For example, the assembly 100 can include a first support member 110 (e.g., first upright, A-pillar). The assembly 100 can include a second support member 120 (e.g., second upright, B-pillar). The assembly 100 can include a module 130 (e.g., holster module, rod/reel holster module). The module 130 can include a first end 155 of the module 130 and a second end 157 of the module 130. The assembly 100 is shown coupled to the sidewall 34 of the bed 30 of the vehicle 10 by a magnet or other attachment device or means (e.g., hook and loop, suction cup, snap, latch, etc.), as further described, below. In the embodiment of FIG. 1, the first support member 110 can rest on a portion of the floor 32 of the bed 30, while the second support member 120 can rest on a portion of the wheel well 36.

The first support member 110 can be configured to removably couple (e.g., easily attach to and be removed from) with the vehicle 10. For example, the first support member 110 can be configured to removably couple with the sidewall 34 of the vehicle 10. The first support member 110 can attach to the sidewall 34 of the vehicle 10 and can be removed from the sidewall 34 of the vehicle 10. The first support member 110 can attach to the sidewall 34 of the vehicle 10 via the magnet or other attachment device. The first support member 110 can be configured to removably couple with the floor 32 of the bed 30 of the vehicle 10. For example, the first support member 110 can be configured to removably couple with the floor 32 of the bed 30 of the truck. The first support member 110 can be supported by the floor 32 of the vehicle 10. The first support member 110 can rest on the floor 32 of the vehicle 10. The first support member 110 can engage with the floor 32 of the vehicle 10. The first support member 110 can abut the floor 32 of the vehicle. The floor 32 of the vehicle 10 can support the first support member 110. A bottom portion of the first support member 110 can be configured to contact a top portion of the floor 32 of the vehicle 10.

The second support member 120 can be configured to removably couple with the vehicle 10. For example, the second support member 120 can couple with the sidewall 34 of the vehicle 10. For example, the second support member 120 can be configured to removably couple with the wheel well 36. The second support member 120 can be configured to removably couple with the wheel well 36 in a cargo area of the vehicle 10. The second support member 120 can be configured to removably couple with the wheel well 36 in the bed 30 of the vehicle 10. The second support member 120 can be supported by the wheel well 36. The second support member 120 can rest on the wheel well 36. The second support member 120 can engage with the wheel well 36. The second support member 120 can abut the wheel well 36. The wheel well 36 can support the second support member 120. A bottom portion of the second support member 120 can be configured to contact a top port of the wheel well 36. In some embodiments, the second support member 120 can be configured to removably couple with the bed 30. For example, the second support member 120 can be configured to removably couple with the floor 32 of the vehicle 10.

The module 130 can include one or more holsters 140, 150, 160. The one or more holsters 140, 150, 160 can be arranged in a vertical stack. For example, two holsters of the one or more holsters can be oriented such that first holster is disposed above a second holster, in use, or an operable configuration. For example, two holsters of the one or more holsters can be oriented such that first holster is disposed above a second holster with the support members 110, 120 coupled with the sidewall 34 of the vehicle 10. A first end 165 of the one or more holsters 140, 150, 160 can be open (e.g., exposed, as in an open-end tube) or closed (e.g., unexposed, as in a closed-end tube). A second end 167 of the one or more holsters 140, 150, 160 can be open or closed. For example, the first end 165 of the one or more holsters 140, 150, 160 can be open and the second end 167 of the one or more holsters 140, 150, 160 can be closed. The first end 165 of the one or more holsters 140, 150, 160 can be open and the second end 167 of the one or more holsters 140, 150, 160 can be open. The first end 165 of the one or more holsters 140, 150, 160 can be open to aid in the insertion or removal of the fishing rod and fishing feel (e.g., fishing rod/reel). For example, a user can insert or remove the fishing rod/reel into the assembly 100 without having to open a covering for the fishing rod/reel.

The one or more holsters 140, 150, 160 can include a first holster, a second holster, and a third holster. In use, or in an operable configuration, the second holster can be disposed below the first holster. For example, the second holster can be disposed below the first holster a first distance from the first holster. The third holster can be disposed below the second holster. For example, the third holster can be disposed below the second holster a second distance from the second holster. The first distance can be the same as or different from the second distance. The first holster, the second holster, and the third holster can be arranged in a vertical stack. The first holster, the second holster, and the third holster can be arranged in a horizontal stack. The one or more holsters 140, 150, 160 can include three holsters. The one or more holsters 140, 150, 160 can include fewer than or more than three holsters.

Each of the one or more holsters 140, 150, 160 can include a notch 145 (e.g., groove). The notch 145 can be disposed at a first end 165 of the one or more holsters 140, 150, 160. The notch 145 can receive or accommodate a fishing reel. The notch 145 can be configured to couple with a fishing reel. For example, the notch 145 can engage with the fishing reel. The notch can engage with a reel seat (e.g., saddle) of the fishing reel. The notch 145 can receive the fishing reel. The notch 145 can secure the fishing reel to the one or more holsters 140, 150, 160. The notch 145 can prevent the fishing reel/rod from sliding out of the one or more holsters 140, 150, 160. For example, the notch 145 can prevent the fishing reel/rod from sliding out of the one or more holsters 140, 150, 160 during transport of the fishing reel/rod.

Each of the one or more holsters 140, 150, 160 can define a housing configured to receive a fishing rod. The housing can include a tube. For example, the housing can include a cylindrical tube (e.g., hollow cylindrical tube). The housing can include an elongate, hollow housing configured to receive the fishing rod. The fishing rod can be inserted into the housing. The fishing rod can be removed from the housing. The assembly 100 can be configured to receive the fishing rod within an interior of the one or more holsters 140, 150, 160. For example, the assembly 100 can be configured to receive the fishing rod, for example an elongate shaft of the fishing rod, within an interior of the housing of the one or more holsters 140, 150, 160. The fishing reel can be disposed exterior (partially or fully) to the one or more holsters 140, 150, 160. The fishing reel can be disposed exterior to the first holster of the one or more holsters 140, 150, 160. For example, the assembly 100 can be configured to receive the fishing rod within the interior of the housing of the one or more holsters 140, 150, 160 and with the fishing reel disposed exterior to the one or more holsters 140, 150, 160. The assembly 100 can be configured to receive the fishing rod within the interior of the housing of a first holster of the one or more holsters 140, 150, 160 and with the fishing reel disposed exterior to the first holster of the one or more holsters 140, 150, 160. The fishing rod can be configured to be disposed in the interior of the housing of the one or more holsters 140, 150, 160. For example, the fishing rod can be configured to be disposed in the interior of the housing of the first holster the one or more holsters 140, 150, 160. The fishing reel is configured to be disposed exterior of the housing of the one or more holsters 140, 150, 160. For example, the fishing reel is configured to be disposed exterior of the housing of the first holster of the one or more holsters 140, 150, 160.

The first support member 110 can be coupled with (e.g., secured to) the module 130. For example, the first support member 110 can be coupled with or at the first end 155 of the module 130. The first support member 110 can be coupled with a portion of the module 130 between the first end 155 of the module 130 and the second end 157 of the module 130. The first support member 110 can be disposed closer to the first end 155 of the module 130 than to the second end 157 of the module 130. The first support member 110 can be coupled with the module 130 at a position between the first end 155 of the module 130 and the second end 157 of the module 130. For example, the first support member 110 can be disposed between the first end 155 of the module 130 and the second end 157 of the module 130.

The second support member 120 can be coupled with (e.g., secured to) the module 130. For example, the second support member 120 can be coupled with the second end 157 of the module 130. The second support member 120 can be coupled with a portion of the module 130 between the first end 155 of the module 130 and the second end 157 of the module 130. For example, the second support member 120 can be coupled with a portion of the module 130 about halfway between the first end 155 of the module 130 and the second end 157 of the module 130. The second support member 120 can be disposed closer to the second end 157 of the module 130 than to the first end 155 of the module 130. The second support member 120 can be coupled with the module 130 at a position between the first end 155 of the module 130 and the second end 157 of the module 130. For example, the second support member 120 can be disposed between the first end 155 of the module 130 and the second end 157 of the module 130. The second support member 120 can be displaced (e.g., offset) a distance from the first support member 110.

The assembly 100 can be disposed in the bed 30 of a light truck having the tailgate 38. With one or more holsters 140, 150, 160 loaded with a fishing rod/reel, the tailgate 38 may be closed and can serve to prevent the fishing rod/reel from leaving the one or more holsters 140, 150, 160. In one embodiment, each holster of the one or more holsters 140, 150, 160 may be configured with a mechanism (e.g., a cap, a strap, an elastic retention band, etc.) for retention of a fishing rod/reel. In one embodiment, the module 130 may be configured with a retention mechanism (e.g., a cover, a strap, an elastic band, etc.) for retention of each fishing rod/reel.

The light truck is used for convenience of the disclosure only and not by way of limitation, as the present disclosure anticipates employing the assembly 100 with other vehicle types and even without a vehicle. By way of further non-limiting examples, the assembly 100 may be disposed to a sport-utility vehicle, a towable trailer, a light utility vehicle, an aircraft, a boat, a storage unit, a garage, a basement, a porch, etc. Similarly, the assembly 100 is shown disposed at the sidewall 34 and over the wheel well 36 for convenience of the disclosure and not be way of limitation. By way of additional non-limiting examples, the assembly 100 may be disposed at an opposite sidewall, to a surface of the bed 32, to ceiling (inside) or roof (outside) of a shell covering the bed 30, to an interior or exterior wall surface of a towable trailer, or to any suitable portion of a vehicle (or non-vehicle).

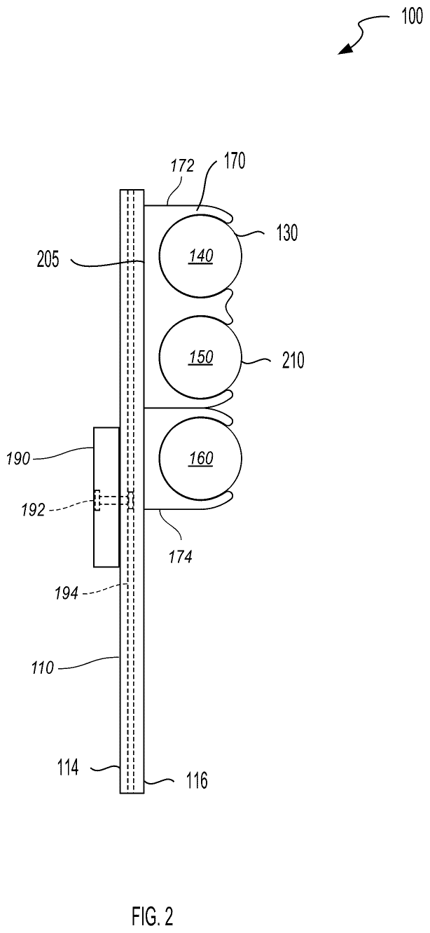

FIG. 2 illustrates a rear view of the assembly 100 of FIG. 1. The first support member 110 is shown for reference. The assembly 100 can include one or more magnets 190. The magnet 190 can facilitate attachment of the assembly 100 to a metal structure. The magnet 190 can be disposed on the first support member 110. For example, the magnet 190 can be disposed on a first side 114 of the first support member 110. The magnet 190 can be attached to the first side 114 of the first support member 110. The magnet 190 can be disposed on the second support member 120. The magnet 190 can be disposed on a lateral, outer surface of the first support member 110 to couple the assembly 100 to a support structure such as the sidewall 34 of a truck bed. The magnet 190 may be coupled to the first support member 110 by means of a bolt 192, or by any suitable means. For example, the magnet 190 can be fixedly attached to the first support member 110. In one embodiment, the magnet 190 may be coupled to the first support member 110 in a fixed position. In one embodiment, the magnet 190 may be adjustably coupled to the first support member 110. By way of non-limiting example, a bolt rail 194 may be disposed at or within the first support member 110, permitting the magnet 190 to be disposed upward or downward from a first position to accommodate a particular installation. The magnet 190 can allow the first support member 110 to removably couple with the vehicle 10. For example, the magnet 190 can allow the first support member 110 to be easily attached to and removed from the vehicle 10. The magnet 190 can allow the first support member 110 to be easily attached to and removed from the sidewall 34 of the vehicle 10. The magnet 190 can be fixedly coupled with the first support member 110 and removably coupled with the sidewall 34 of the vehicle 10.

The module 130 can be disposed on the first support member 110. For example, the module 130 can be disposed on a second side 116 of the first support member 110. The module 130 can be attached to the second side 116 of the first support member 110. The second side 116 of the first support member 110 can be disposed opposite the first side 114 of the first support member 110. The magnet 190 and the module 130 can be disposed on opposite sides of the first support member 110.

The module 130 can include one or more holsters 140, 150, 160. For example, the module 130 can include a plurality of holsters 140, 150, 160. Each holster of the one or more holsters 140, 150, 160 can define or otherwise include an elongate, hollow (e.g., tubular) housing to receive a fishing rod. Each holster of the one or more holsters 140, 150, 160 may be formed of a suitable material, such as polyvinyl chloride (PVC), acrylonitrile butadiene styrene (ABS), wood, bamboo, aluminum, or a combination of materials. Each holster of the one or more holsters 140, 150, 160 may be formed through cutting and assembling appropriate materials, by extrusion, by molding, by 3D printing, or by any other suitable means. While the one or more holsters 140, 150, 160 are shown having a circular cross-section, this is for convenience of the disclosure, as other cross-sectional forms (e.g., polygonal, ovoid, square, rectangle, etc.) are anticipated.

The module 130 can include a first side 205 of the module 130 and a second side 210 of the module 130. The first support member 110 can be coupled with the first side of the module 130. For example, the first support member 110 can abut the first side of the module 130. The first support member 110 can be attached to the first side of the module 130. Each notch 145 can be disposed on the second side 210 of the module 130. The second side 210 of the module 130 can be disposed opposite the first side 205 of the module 130.

The assembly 100 can include one or more bracket assemblies. For example, the assembly 100 can include a first bracket assembly 170. Each holster of the one or more holsters 140, 150, 160 can be coupled to the first support member 110 by means of the first bracket assembly 170. In the embodiment of FIG. 2, the first bracket assembly 170 is shown comprising a double holster-bracket 172 and a single holster-bracket 174. In one embodiment, all three holsters of the one or more holsters 140, 150, 160 may be coupled to the first support member 110 by means of one (triple holster) bracket, or by means of three single holster-brackets 174. In an embodiment having four holsters of the one or more holsters 140, 150, 160, the first bracket assembly 170 may include a single quadruple holster-bracket, two double holster-brackets, four single holster-brackets, etc. Each bracket 172, 174 may be formed of PVC, ABS, wood, metal, or a combination of materials. Each bracket 172, 174 may be formed by cutting, molding, extruding, 3D printing, or any other suitable method of manufacture. In one embodiment, the module 130 may be unitary, meaning that the holsters of the one or more holsters 140, 150, 160 and the first bracket assembly 170 are manufactured as a consolidated unit. In one embodiment, the first bracket assembly 170 may be unitary to the first support member 110 (and/or any other support member, such as, the second support member 120 of FIGS. 1, 4, and 5), meaning that the first support member 110 and/or second support member 120 and the first bracket assembly 170 are manufactured as a unit.

It should be noted that the embodiment illustrated in FIG. 2 comprises three holsters. However, this is for convenience of the disclosure and not by way of limitation as the present disclosure anticipates embodiments having more or fewer holsters.

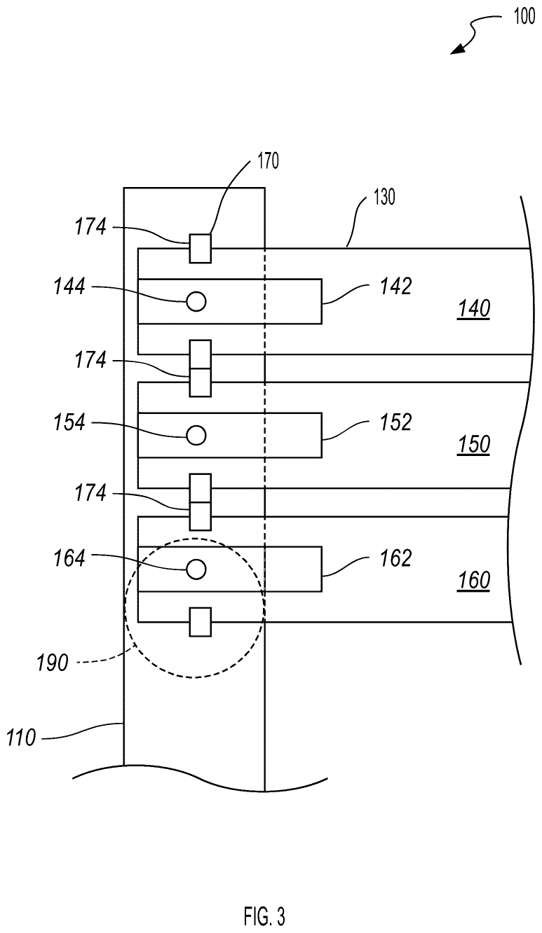

FIG. 3 illustrates a partial side view of the assembly 100. The assembly 100 can include one or more notches 145. The one or more notches can include reel accommodations 142, 152, 162. The first support member 110 is identified for reference. In the embodiment of FIG. 3, the first bracket assembly 170 include three single holster-brackets 174. The module 130 has three holsters of the one or more holsters 140, 150, 160. The holsters of the one or more holsters 140, 150, 160 are shown each having a fastener 144, 154, 164, respectively, coupling each holster of the one or more holsters 140, 150, 160 to at least one of the first bracket assembly 170 and the first support member 110. In some embodiments, the fasteners 144, 154, 164 may be omitted. The holster 140 has a reel accommodation 142. Similarly, the holsters 150 and 160 have reel accommodations 152 and 162, respectively. When a fishing rod/reel is placed in any holster of the one or more holsters 140, 150, 160, the tip of the rod can be first inserted and the rod can then be advanced in the one or more holsters 140, 150, 160 until the reel reaches the one or more holsters 140, 150, 160, at which point the rod may be rotated to permit further advancing the fishing rod/reel by aligning a reel foot and post with the reel accommodation 142, 152, 162.

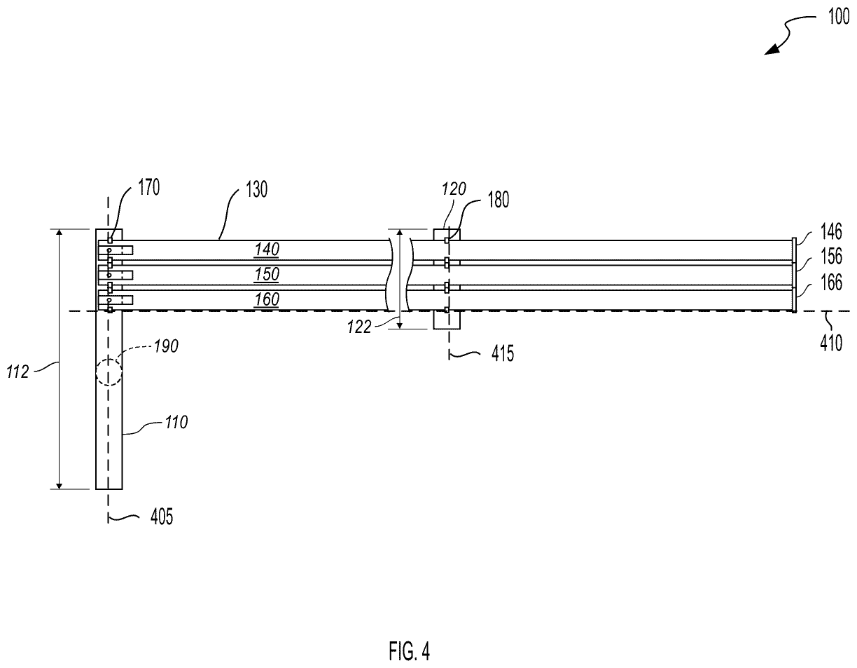

FIG. 4 illustrates a side view of the assembly 100. The assembly 100 can include the first support member 110, the second support member 120, the module 130, the one or more holsters 140, 150, 160, and the magnet 190. A height 112 of the first support member 110 is shown. A height 122 of the second support member 120 is also shown. The height 112 of the first support member 110 and the height 122 of the second support member 120 may relate to the area of disposition of the assembly 100. In the present embodiment, the assembly 100 is disposed in a bed of a light truck, the bed having a wheel well (see the vehicle 10, the bed 30, and the wheel well 36 in FIG. 1). The height 112 of the first support member 110 and the height 122 of the second support member 120 may be configured to dispose the one or more holsters 140, 150, 160 approximately parallel to the bed 30 and above the wheel well 36, and also below a covering for the bed 30 that may be installed at any time. The height 112 of the first support member 110 and the height 122 of the second support member 120 may differ depending on the configuration of the space into which the assembly 100 is to be installed. By way of example without limitation, the vehicle 10 has a narrow bed 30, there may be no wheel well 36 to be accommodated, permitting the first support member 110 and the second support member 120 to be of the same height 112 (and also potentially permitting more holsters).

The first support member 110 can have a first length (e.g., height 112). The second support member 120 can have a second length (e.g., height 122). The second length can be less than the first length. For example, the length of the first support member 110 can be less than the length of the second support member 120. The difference in length between the first support member 110 and the second support member 120 can be used to accommodate the difference in height between the bed 30 and the wheel well 36. The second length can be equal to the first length. For example, the length of the first support member 110 can be equal to the length of the second support member 120.

The first support member 110 can have a longitudinal axis 405 oriented perpendicular to a longitudinal axis 410 of the one or more holsters 140, 150, 160. The longitudinal axis 405 of the first support member 110 can be oblique to the longitudinal axis 410 of the one or more holsters 140, 150, 160. The second support member 120 can have a longitudinal axis 415 oriented perpendicular to the longitudinal axis 410 of the one or more holsters 140, 150, 160. The longitudinal axis 415 of the second support member 120 can be oblique to the longitudinal axis 410 of the one or more holsters 140, 150, 160.

The second support member 120 can be disposed to rest atop the wheel well 36. The second support member 120 may disposed further forward or rearward in the bed 30. A second bracket assembly 180 can couple the module 130 to the second support member 120. The second bracket assembly 180 may be substantially similar to the first bracket assembly 170.

The module 130 can include one or more end caps 146, 156, 166. The one or more end caps 146, 156, 166 can be disposed at the forward end of each of the one or more holsters 140, 150, 160, respectively. The forward end of each of the one or more holsters 140, 150, 160 can correspond to the second end 157 of the module 130. The one or more end caps 146, 156, 166 may prevent foreign objects and/or fauna from entering the forward end of the one or more holsters 140, 150, 160, thereby protecting a fishing rod/reel from possible damage. In one embodiment, the one or more end caps 146, 156, 166 may be formed independently and applied to the one or more holsters 140, 150, 160. In one embodiment, each end cap 146, 156, 166 may be manufactured or otherwise formed so as to be unitary or integral to the respective one or more holsters 140, 150, 160.

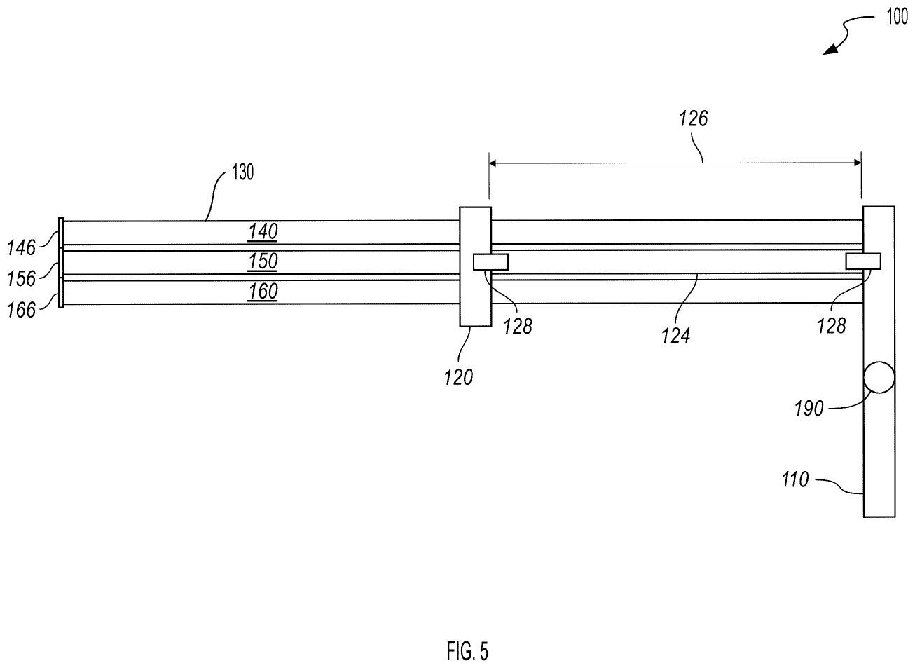

FIG. 5 illustrates an opposite side view of the assembly 100. The assembly 100 can include the first support member 110, the second support member 120, the module 130, the one or more holsters 140, 150, 160, the end caps 146, 156, 166, and the magnet 190. The assembly 100 can include a longitudinal support member 124. The longitudinal support member 124 can be disposed between the first support member 110 and the second support member 120. The longitudinal support member 124 can couple the first support member 110 with the second support member 120. The longitudinal support member 124 may provide stability and strength to the assembly 100. The longitudinal support member 124 has a length 126 equal, or approximately equal to a distance between the first support member 110 and the second support member 120. The longitudinal support member 124 may be formed of PVC, ABS, wood, metal, or a combination of materials. The longitudinal support member 124 may be formed by cutting, molding, extruding, 3D printing, or by any other suitable method of manufacture. Coupling members 128 can couple the longitudinal support member 124 to the first support member 110 and the second support member 120. In one embodiment, the coupling members 128 may be unitary or integral to the longitudinal support member 124. In one embodiment, the coupling members 128 may be unitary to each of the first support member 110 and the second support member 120. In one embodiment, the first support member 110, the second support member 120, the longitudinal support member 124, and the coupling members 128 may be manufactured as a single, unitary component. In one embodiment, the first support member 110, the second support member 120, and the longitudinal support member 124 may be manufactured as a unitary component omitting the coupling members 128.

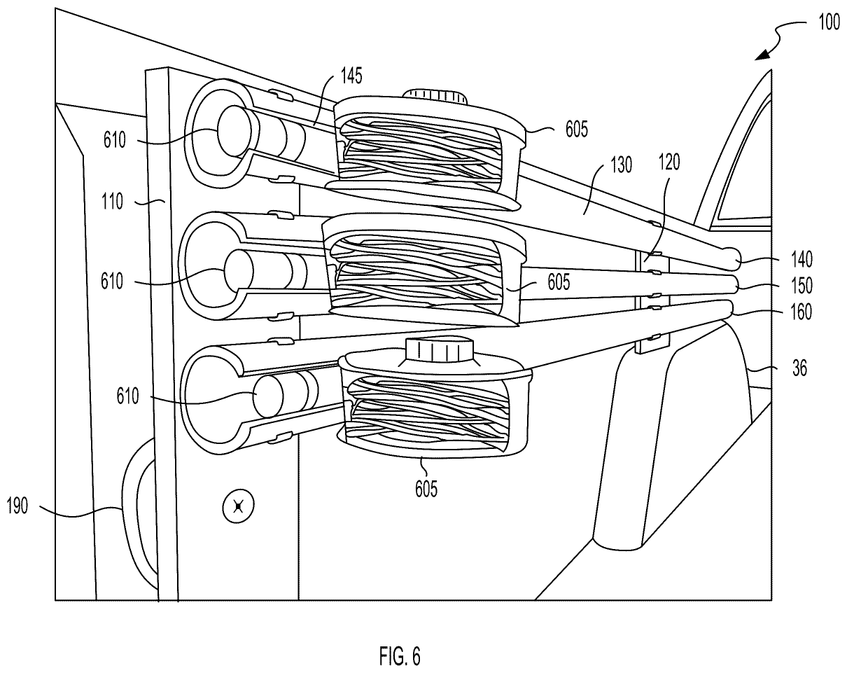

FIG. 6 illustrates a perspective view of the assembly 100. The assembly 100 can include the first support member 110, the second support member 120, the module 130, the one or more holsters 140, 150, 160, the notch 145, and the magnet 190. Each of the one or more holsters 140, 150, 160 can include the notch 145. The notch 145 can be configured to couple with the fishing reel (e.g., fishing reel 605). For example, the fishing reel 605 can engage with the notch 145. The fishing reel 605 can engage with the notch 145 when the fishing rod 610 is disposed into the one or more holsters 140, 150, 160. Each of the one or more holsters 140, 150, 160 can define a housing configured to receive the fishing rod (e.g., fishing rod 610). For example, the holster 140 can receive the fishing rod 610. The notch 145 of holster 140 can couple with the fishing reel 605. The holster 150 can receive the fishing rod 610. The notch 145 of holster 150 can couple with the fishing reel 605. The holster 160 can receive the fishing rod 610. The notch 145 of holster 160 can couple with the fishing reel 605. When the fishing rods 610 are disposed in the one or more holsters 140, 150, 160, the fishing reels 605 can be arranged in a vertical stack. The fishing rods 610 can be separated from each other when the fishing rods 610 are disposed in the one or more holsters 140, 150, 160. The fishing reels 605 can be separated from each other when the fishing rods 610 are disposed in the one or more holsters 140, 150, 160.

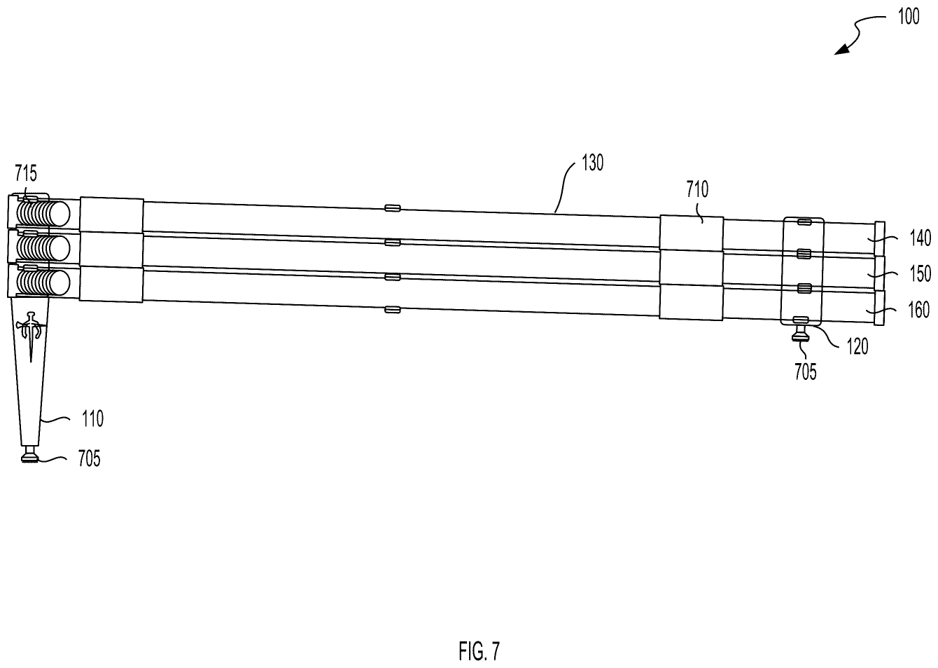

FIG. 7 illustrates a side view of the assembly 100. The assembly 100 can include the first support member 110, the second support member 120, the module 130, and the one or more holsters 140, 150, 160. The assembly 100 can be made of one or more injected molded components (e.g., parts). The assembly 100 can include a handle for transportation of the assembly 100.

The one or more holsters 140, 150, 160 can have a telescopic design. For example, the length of the one or more holsters 140, 150, 160 can changed (e.g., extended or reduced). The length of the one or more holsters 140, 150, 160 can be changed to accommodate different truck bed lengths. For example, the length of the one or more holsters 140, 150, 160 can be in a range of 1 feet to 3 feet. The one or more holsters 140, 150, 160 can be made of various materials such as steel and/or aluminum. The first support member 110 can slide along the one or more holsters 140, 150, 160. The second support member 120 can slide along the one or more holsters 140, 150, 160. The one or more holsters 140, 150, 160 can have a module design. For example, the one or more holsters 140, 150, 160 can be modular for case of shipping and can have customizable configurations to fit various truck beds.

The one or more holsters 140, 150, 160 can be coupled with the first support member 110 via the bracket assembly (e.g., first bracket assembly 170, second bracket assembly 180). The bracket assembly can include a receiving member. The bracket assembly can include an integrated hook. The one or more holsters 140, 150, 160 can be coupled with the second support member 120 via the bracket assembly. The bracket assembly can be designed to securely hold the one or more holsters 140, 150, 160. The bracket assembly can include anti-rotation mechanisms to prevent the rotation of the one or more holsters 140, 150, 160. The integrated hook can provide a sufficient snap-on force to securely hold the one or more holsters 140, 150, 160. The bracket assembly can ensure that each of the one or more holsters 140, 150, 160 remains in position. The bracket assembly can ensure that each of the one or more holsters 140, 150, 160 are physically separated from one another. The bracket assembly can prevent contact of the one or more holsters 140, 150, 160. The bracket assembly can provide stiffness and/or rigidity while moving the assembly 100 between the vehicle 10 and storage.

The bracket assembly can maintain the angle of each of the one or more holsters 140, 150, 160. The one or more holsters 140, 150, 160 can be angled downward (e.g., the second end 167 of the one or more holsters 140, 150, 160 can be lower than the first end 165 of the one or more holsters 140, 150, 160). The angle of the one or more holsters 140, 150, 160 can prevent slippage of the fishing rod 610. For example, the angle of the one or more holsters 140, 150, 160 can prevent the fishing rod 610 from sliding out of the one or more holsters 140, 150, 160. The one or more holsters 140, 150, 160 can be parallel to the bed 30 (e.g., the second end 167 of the one or more holsters 140, 150, 160 can be level with the first end 165 of the one or more holsters 140, 150, 160).

The assembly 100 can include one or more leveling legs 705. The leveling leg 705 can include a ball bearing. The first support member 110 can include the leveling leg 705. The leveling leg 705 can allow for the adjustment of the height of the first support member 110. The ball bearing can allow for smooth adjustment of the leveling leg 705 to the floor 32 of the bed 30 of the vehicle 10. The second support member 120 can include the leveling leg 705. The leveling leg 705 can allow for the adjustment of the height of the second support member 120. The ball bearing can allow for smooth adjustment of the leveling leg 705 to the wheel well 36. The first support member 110 or the second support member 120 can be adjusted to fit other structures. For example, the first support member 110 or the second support member 120 can be adjusted to fit other structures for storing different items (e.g., guns, tools).

The assembly 100 can include a connector 710. The connector 710 can couple a first tube and a second tube of the one or more holsters 140, 150, 160. The connector 710 can ensure a flush internal connection between the first tube and the second tube. This can prevent obstruction and damage to the fishing rod 610. The interior of the one or more holsters 140, 150, 160 can be smooth such that the fishing rod 610 does not catch or snag on the one or more holsters 140, 150, 160.

The assembly 100 can include one or more main caps 715. The main cap 715 can cover the first end 165 of the one or more holsters 140, 150, 160. The main cap 715 can be designed to secure the fishing rod 610. The main cap 715 can have adjustable features to fit different fishing rod types and sizes. The main cap 715 can include customizable diameter cuts to allow the fishing rod 610 to stick out of the one or more holsters 140, 150, 160. The main cap 715 can include a tongue with different cuts to press against the fishing rod 610. The tongue can prevent movement of the fishing rod 610. The tongue can sit flush on the interior of the one or more holsters 140, 150, 160.

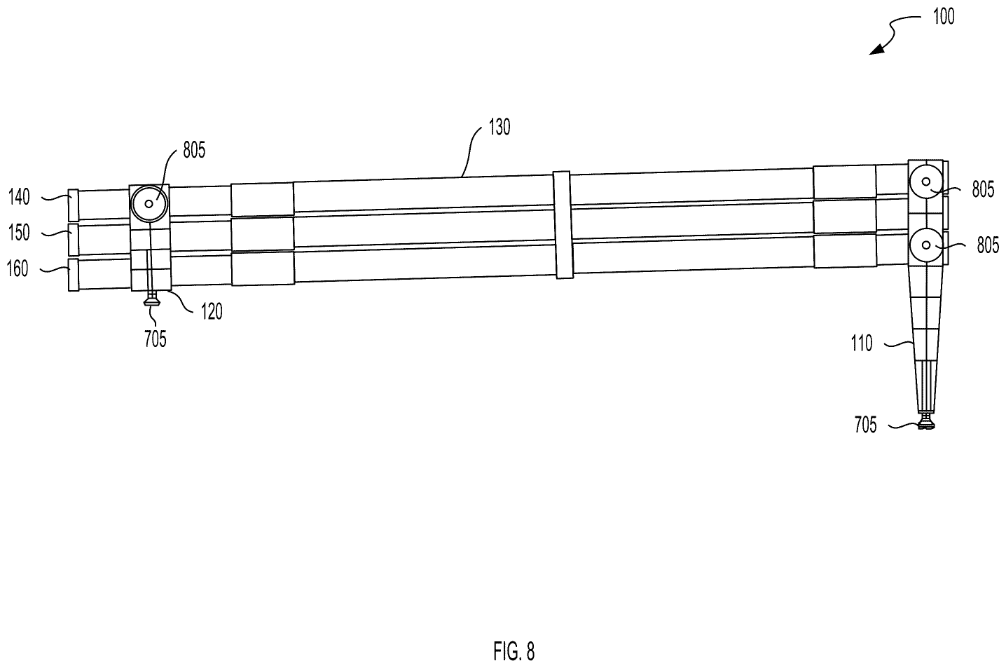

FIG. 8 illustrates an opposite side view of the assembly 100. The assembly 100 can include the first support member 110, the second support member 120, the module 130, and the one or more holsters 140, 150, 160.

The assembly 100 can include one or more magnet slots 805. The magnet slot 805 can receive the magnet 190 (e.g., neodymium magnet). The magnet 190 can be inserted into the magnet slot 805. The first support member 110 can include the one or more magnet slots 805. The second support member 120 can include one or more magnet slots 805. The one or more magnet slots 805 can accommodate the pull force of neodymium magnets (e.g., 66 pounds of pull force). Each magnet slot 805 can receive the one or more magnets 190.

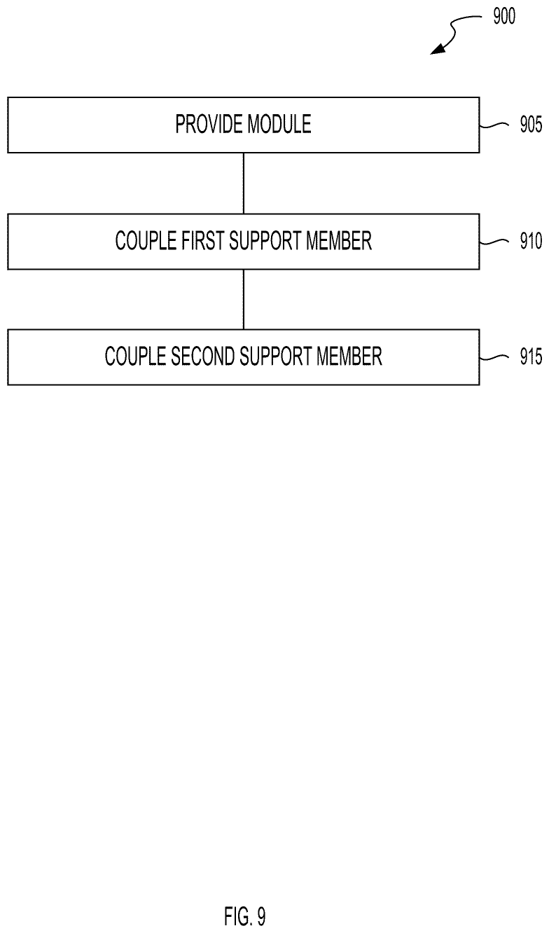

FIG. 9 illustrates a method 900 of storing fishing equipment. In brief summary, the method 900 can include providing a module (BLOCK 905). The method 900 can include coupling a first support member (BLOCK 910). The method 900 can include coupling a second support member (BLOCK 915).

The method 900 can include providing a module (BLOCK 905). The module can include one or more holsters. Each of the one or more holsters can include a notch. The notch can be disposed at a first end of the one or more holsters. The notch can be configured to couple with a fishing reel. Each of the one or more holsters can define a housing configured to receive a fishing rod. The first end of each of the one or more holsters can be open.

The method 900 can include coupling a first support member (BLOCK 910). For example, the method 900 can include coupling the first support member with a first end of the module. The first support member can have a first length. The method 900 can include coupling the first support member with a first side of the module. The method 900 can include disposing each notch on a second side of the module. The second side of the module can be disposed opposite the first side of the module.

The method 900 can include coupling a second support member (BLOCK 915). For example, the method 900 can include coupling the second support member with a portion of the module between the first end of the module and a second end of the module. The second support member can have a second length. The second length can be less than the first length.

The method 900 can include disposing a magnet on a first side of the first support member. The method 900 can include disposing the module on a second side of the first support member. The second side of the first support member can be disposed opposite the first side of the first support member.

The method 900 can include arranging the one or more holsters in a vertical stack. The method 900 can include disposing a second holster below a first holster a first distance from the first holster. The method 900 can include disposing a third holster below the second holster a second distance from the second holster.

It should be noted that, while the foregoing embodiments are discussed in the context of a light truck, and, more particularly, to a cargo area of the light truck, this is for convenience of the disclosure only, and not by way of limitation. The systems and methods herein disclosed can be implemented with (e.g., disposed in), another area of the light truck, in a sport-utility vehicle, a light utility vehicle, a truck other than a light truck, a boat, an aircraft, a trailer, a storage unit/shed, a portion of a building, etc. Similarly, the present disclosure anticipates an embodiment wherein the assembly 100 is used to store fishing rods/reels, e.g., at a home, with the assembly 100 moved from the home to a vehicle for transport of the fishing rods/reels without removal from assembly 100.

### Examples

Some examples of embodiments of the present disclosure are now provided.

Example 1. An assembly comprising: a module comprising one or more holsters each comprising a notch disposed at a first end of the one or more holsters and configured to couple with a fishing reel, each of the one or more holsters defining a housing configured to receive a fishing rod; a first support member coupled with a first end of the module; and a second support member coupled with a portion of the module between the first end of the module and a second end of the module.

Example 2. The assembly of Example 1, comprising: a magnet disposed on a first side of the first support member, wherein the module is disposed on a second side of the first support member, the second side of the first support member disposed opposite the first side of the first support member.

Example 3. The assembly of Example 1, wherein the first support member is configured to removably couple with a sidewall of a vehicle.

Example 4. The assembly of Example 1, wherein the second support member is configured to removably couple with a wheel well in a cargo area of a vehicle.

Example 5. The assembly of Example 1, wherein: the first support member is coupled with a first side of the module, and each notch is disposed on a second side of the module, the second side of the module disposed opposite the first side of the module.

Example 6. The assembly of Example 1, wherein the one or more holsters are arranged in a vertical stack.

Example 7. The assembly of Example 1, wherein the first support member has a first length and the second support member has a second length less than the first length.

Example 8. The assembly of Example 1, wherein a first end of each of the one or more holsters is open and a second end of each of the one or more holsters is closed.

Example 9. The assembly of Example 1, wherein a first end of each of the one or more holsters is open and a second end of each of the one or more holsters is open.

Example 10. The assembly of Example 1, wherein the first support member is configured to removably couple with a floor of a bed of a truck.

Example 11. The assembly of Example 1, wherein assembly is configured to receive the fishing rod within an interior of the housing of the one or more holsters and with the fishing reel disposed exterior to the one or more holsters.

Example 12. The assembly of Example 1, wherein the one or more holsters comprises: a first holster; a second holster disposed below the first holster a first distance from the first holster; and a third holster disposed below the second holster a second distance from the second holster.

Example 13. The assembly of Example 1, wherein the housing comprises a tube.

Example 14. A method, comprising: providing a module comprising one or more holsters each comprising a notch disposed at a first end of the one or more holsters and configured to couple with a fishing reel, each of the one or more holsters defining a housing configured to receive a fishing rod; coupling a first support member with a first end of the module; and coupling a second support member with a portion of the module between the first end of the module and a second end of the module.

Example 15. The method of Example 14, comprising: disposing a magnet on a first side of the first support member; and disposing the module on a second side of the first support member, the second side of the first support member disposed opposite the first side of the first support member.

Example 16. The method of Example 14, comprising: arranging the one or more holsters in a vertical stack.

Example 17. The method of Example 14, wherein the first support member has a first length and the second support member has a second length less than the first length.

Example 18. The method of Example 14, comprising: coupling the first support member with a first side of the module, and disposing each notch on a second side of the module, the second side of the module disposed opposite the first side of the module.

Example 19. The method of Example 14, comprising: disposing a second holster below a first holster a first distance from the first holster; and disposing a third holster below the second holster a second distance from the second holster.

Example 20. The method of Example 14, wherein the first end of each of the one or more holsters is open.

Example 21. A fishing rod holster assembly comprising: a rod holster module comprising one or more holsters each defining an elongate hollow housing configured to receive a fishing rod; a first upright to support the rod holster module at a first position, the first upright having a longitudinal axis oriented perpendicular to a longitudinal axis of the one or more holsters; a first bracket assembly to couple the rod holster module to the first upright; a second upright to support the rod holster module at a second position, the second upright having a longitudinal axis oriented perpendicular to the longitudinal axis of the one or more holsters; and a second bracket assembly to couple the rod holster module to the second upright.

Example 22. The fishing rod holster assembly of Example 21, further comprising one or more attachment devices to secure one or more of the first upright and the second upright to a sidewall of a vehicle.

Example 23. The fishing rod holster assembly of Example 21, wherein the one or more attachment devices comprises a magnet.

Example 24. The fishing rod holster assembly of Example 21, wherein the first upright is oriented and configured to couple to the holster module at a first end of the holster module and is configured to extend from the holster module downward to rest upon a bed of a truck.

Example 25. The fishing rod holster assembly of Example 21, wherein the second upright is oriented and configured to couple to the holster module at a medial position along the longitudinal axis of the one or more holsters of the holster module and is configured to extend from the holster module downward to rest upon a wheel well in a bed of a truck.

Example 26. The fishing rod holster assembly of Example 21, wherein the elongate hollow housing comprises a cylindrical tubular shape.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementations,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Elements other than ‘A’ and ‘B’ can also be included.

As used herein, the terms “couple,” “coupled,” and “coupling” indicate the placement or positioning of two or more items or components in proximity to each other, and may include, e.g., physical connection of the items or components, mechanical connection (e.g., bolted together, etc.), locational proximity (e.g., placed adjacent each other, etc.), etc. To be coupled, it is not necessary that items be fixedly connected together. Furthermore, two or more items or components may be coupled together by means of or across an intervening or interposed item or component (e.g., a bracket, a washer, a brace, etc.).

The systems and methods described herein may be embodied in other specific forms without departing from the characteristics thereof. The foregoing implementations are illustrative rather than limiting of the described systems and methods.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. An assembly, comprising:
a module comprising one or more holsters each comprising a notch disposed at a first end of the one or more holsters and configured to couple with a fishing reel, each of the one or more holsters defining a housing configured to receive a fishing rod;
a first support member coupled with a first end of the module; and
a second support member coupled with a portion of the module between the first end of the module and a second end of the module.

2. The assembly of claim 1, comprising:
a magnet disposed on a first side of the first support member,
wherein the module is disposed on a second side of the first support member, the second side of the first support member disposed opposite the first side of the first support member.

3. The assembly of claim 1, wherein the first support member is configured to removably couple with a sidewall of a vehicle.

4. The assembly of claim 1, wherein the second support member is configured to removably couple with a wheel well in a cargo area of a vehicle.

5. The assembly of claim 1, wherein:
the first support member is coupled with a first side of the module, and
each notch is disposed on a second side of the module, the second side of the module disposed opposite the first side of the module.

6. The assembly of claim 1, wherein the one or more holsters are arranged in a vertical stack.

7. The assembly of claim 1, wherein the first support member has a first length and the second support member has a second length less than the first length.

8. The assembly of claim 1, wherein a first end of each of the one or more holsters is open and a second end of each of the one or more holsters is closed.

9. The assembly of claim 1, wherein a first end of each of the one or more holsters is open and a second end of each of the one or more holsters is open.

10. The assembly of claim 1, wherein the first support member is configured to removably couple with a floor of a bed of a truck.

11. The assembly of claim 1, wherein assembly is configured to receive the fishing rod within an interior of the housing of the one or more holsters and with the fishing reel disposed exterior to the one or more holsters.

12. The assembly of claim 1, wherein the one or more holsters comprises:
a first holster;
a second holster disposed below the first holster a first distance from the first holster; and
a third holster disposed below the second holster a second distance from the second holster.

13. The assembly of claim 1, wherein the housing comprises a tube.

14. A method, comprising:
providing a module comprising one or more holsters each comprising a notch disposed at a first end of the one or more holsters and configured to couple with a fishing reel, each of the one or more holsters defining a housing configured to receive a fishing rod;
coupling a first support member with a first end of the module; and
coupling a second support member with a portion of the module between the first end of the module and a second end of the module.

15. The method of claim 14, comprising:
disposing a magnet on a first side of the first support member; and
disposing the module on a second side of the first support member, the second side of the first support member disposed opposite the first side of the first support member.

16. The method of claim 14, comprising:
arranging the one or more holsters in a vertical stack.

17. The method of claim 14, wherein the first support member has a first length and the second support member has a second length less than the first length.

18. The method of claim 14, comprising:
coupling the first support member with a first side of the module, and
disposing each notch on a second side of the module, the second side of the module disposed opposite the first side of the module.

19. The method of claim 14, comprising:
disposing a second holster below a first holster a first distance from the first holster; and
disposing a third holster below the second holster a second distance from the second holster.

20. The method of claim 14, wherein the first end of each of the one or more holsters is open.
